(19) United States
(12) Patent Application Publication
(10) Pub. No.: US 2004/0253908 A1
(43) Pub. Date: Dec. 16, 2004

(54) Domestic animal exerciser

(76) Inventor: Angela K. Thiry, Hanover Park, IL (US)

Correspondence Address: McAndrews, Held & Malloy, Ltd., 34th Floor, 500 West Madison Street, Chicago, IL, 60661, US

(21) Appl. No.: 10/406,740

(22) Filed: Apr. 3, 2003

(51) Int. Cl. A63H 33/00

(52) U.S. Cl. 446/491

(57) ABSTRACT

The domestic animal exerciser is a manually operable handheld device which enables a user to provide his or her domestic animal with the exercise it needs while entertaining both the animal and the user. The device can be used to exercise or entertain domestic animals indoors as well as outdoors, and provides wheelchair confined users a method for exercising and playing with their pets. The user of the domestic animal exerciser grasps the handle of the rod member, which dangles an exercising toy by way of a flexible cord attached through an attachment hole at the tope end of the rod member, and which attaches to the exercising toy through connective holes in the exercising toy. By moving around the rod member, the user can control the movement of the exercising toy, which will entice the domestic animal causing the animal to chase, lunge, and pull at the exercising toy. The effect of chasing, lunging, and pulling at the exercising toy is an excellent workout for the domestic animal and much entertainment for the domestic animal and the user.

### CROSS-REFRENCE TO RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Certain embodiments of the present invention relate generally to the field of entertaining and exercising domestic animals. More specifically, certain embodiments of the present invention relate to the use of a manually operable handheld device to enable a user to provide his or her domestic animal with the exercise it needs while entertaining both the animal and the user. Further, the device can be used to exercise or entertain domestic animals indoors as well as outdoors, and provides physically disabled users (i.e. pet owning users confined to wheelchairs) a method for exercising and playing with their pets.

Although several devices are available on the market for entertaining domestic animals, many of these devices tangle easily, include complicated, impractical reels, are designed to train rather than entertain, or are not practical for wheelchair confined users. None of the prior art, taken either singularly or in combination, provide for a safe, easy to use, effective handheld manually operated domestic animal exercising device which is practical and fun for everyone to use, including those confined to wheelchairs seeking a device that will assist them in interacting with their pets.

### BRIEF SUMMARY OF THE INVENTION

In accordance with one embodiment of the invention, an animal exerciser is provided for exercising and entertaining domestic animals. The animal exerciser includes an elongated cylindrical rod member having opposing first and second ends. In one embodiment of the invention, the rod member could be a light, solid, wooden rod. Adjacent the first end of the rod member is a handle for a user to grasp while using the animal exerciser. In one embodiment of the invention, the handle of the rod member may include a grip for the comfort of the user and to prevent a user's hand from slipping off the rod member. Adjacent the second end of the rod member is an attachment point, for example a hole. At the attachment hole, one end of a flexible cord having opposing attachment ends is connected to the rod member. In one embodiment of the invention, the flexible cord could be a length of rope. The opposing end of the flexible cord is attached to an exercising toy, for example through a connective hole. In one embodiment of the invention, the exercising toy could be a hollow rubber ball.

The animal exerciser is manually operated by a user. The user grasps the handle of the rod member and holds the rod member outright so that the flexible cord is unraveled and the exercising toy is left dangling in front of the domestic animal. The user than moves, jerks, pulls, and flings around the rod member which will cause the exercising toy to move around. The movement of the exercising toy will entice a domestic animal to chase it around, and when the domestic animal catches the toy, the domestic animal will tug and pull at the toy. The effect of the domestic animal chasing, lunging, and pulling at the toy will be a great workout for the domestic animal, while the user enjoys playing with and entertaining his or her domestic animal.

### BRIEF DESCRIPTION OF SEVERAL VIEWS OF THE DRAWINGS

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentality shown in the attached drawings.

FIG. 1 illustrates a manually operated domestic animal exerciser for exercising and entertaining a user's domestic animal.

FIG. 2 illustrates an enlarged view of the flexible cord attached through the rod member.

FIG. 3 illustrates an enlarged view of the flexible cord attached through the exercising toy.

### DETAILED DESCRIPTION OF THE INVENTION

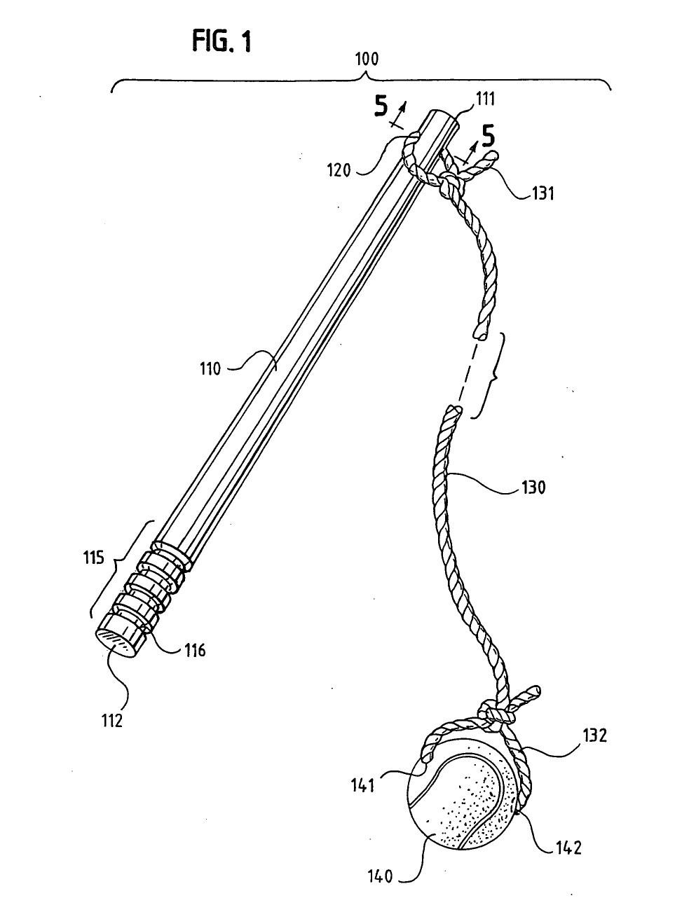

FIG. 1 illustrates one embodiment of the handheld manually operated domestic animal exerciser 100 for use in exercising and entertaining a user's domestic animal. The animal exerciser includes an elongated cylindrical rod member 110 having opposing top 111 and bottom ends 112. In one embodiment of the invention, the rod member 110 could be a light, solid, wooden rod. However, the invention is not intended to be limited to the use of a solid wooden rod. Rather, the rod member 110 may be hollow or solid, and the rod member 110 may be any material capable of sustaining a domestic animal's tugging without breaking. For example, strong plastic material, light metal material, and the like, would be sufficient.

At the bottom end 112 of the rod member is a handle 115 for a user to grasp while using the animal exerciser 100. In one embodiment, the handle 115 of the rod member 110 may include a grip for the comfort of the user and to prevent a user's hand from slipping off the rod member 110. In one embodiment, the grip is comprised of helical or annular groves engraved in the handle 115 of the rod member 110. In another embodiment, the grip is an adhesive textured tape attached to the handle 115 of the rod member 110. The invention is not intended to be limited to engraved helical or annular groves, or adhesive textured tape. Any material which effectively prevents a user's hand from sliding off the handle 115 of the rod member 110 may be used as a grip. Examples of other grips include a tennis racket grip, pine tar, a plastic or rubber bicycle handle grip, the use of sticky or textured gloves, and the like.

At the tope end of the rod member 111 is an attachment hole 120. At the attachment hole 120, one end 131 of a flexible cord 130 having opposing attachment ends (131-132) is connected to the rod member 110. In one embodiment of the invention, the flexible cord 130 could be a length of rope. However, the invention is not intended to be limited to the use of rope. Rather, any sturdy, flexible cord may be used. Examples of other sturdy, flexible cords include fishing line, string, and the like.

The opposing end 132 of the flexible cord 130 attaches through two connective holes (141-142) in an exercising toy 140. In one embodiment of the invention, the exercising toy 140 could be a hollow rubber ball. However, the invention is not intended to be limited to the use of a hollow ball. Rather, any toy-like device capable of safely stimulating an animal's attention may be used. Examples of other exercising toys include, solid rubber balls, waffle balls, squishy hollow rubber toys, bones, cloth doll-like characters, and the like.

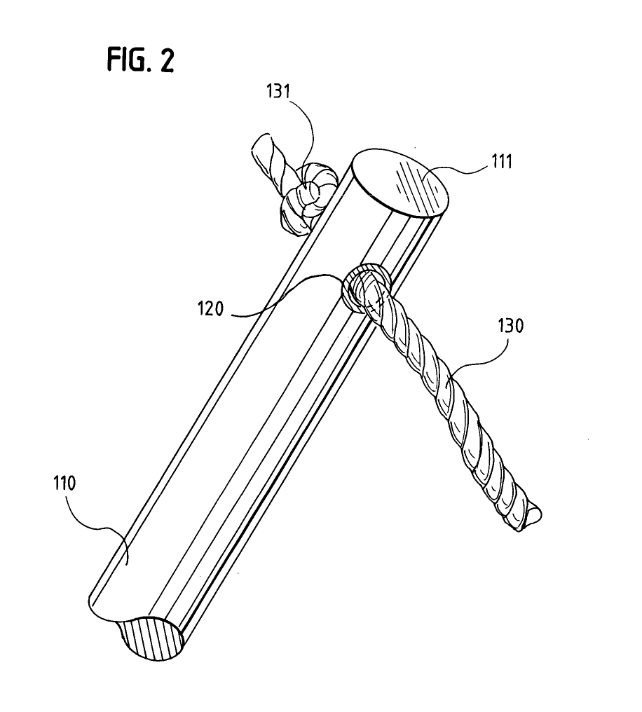

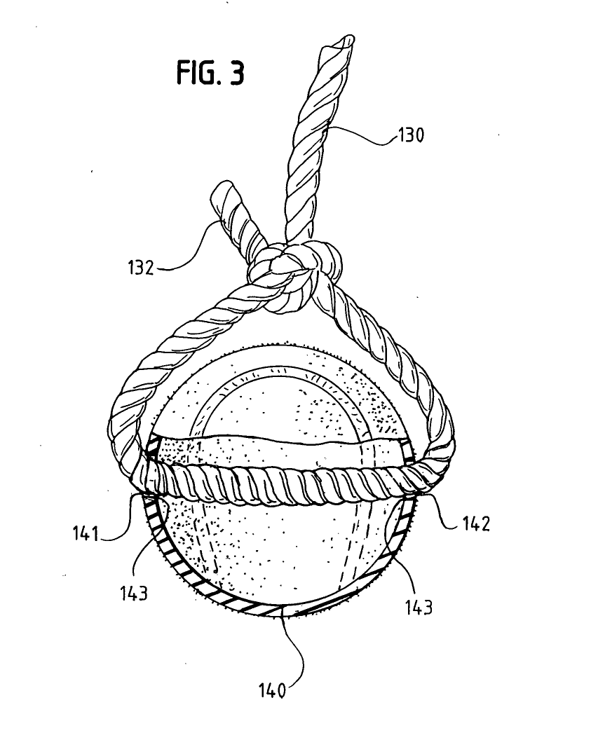

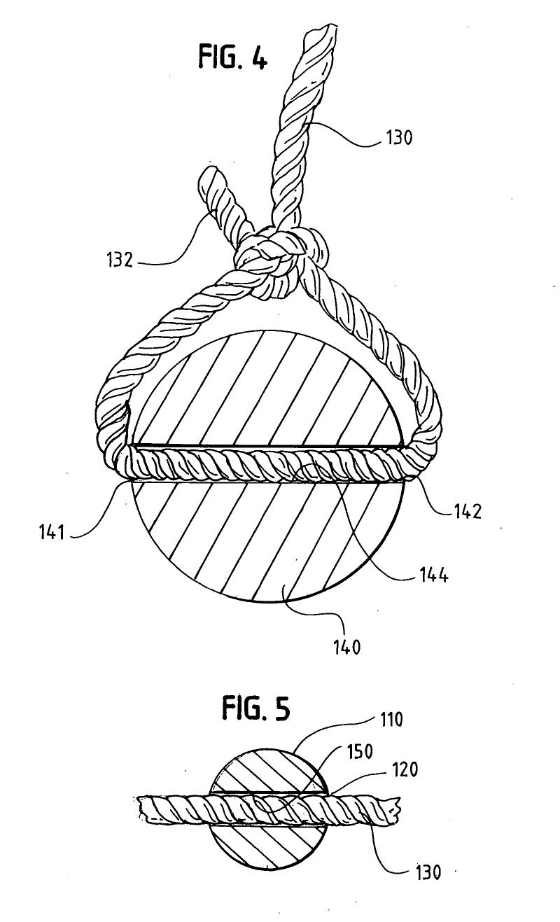

FIG. 2 illustrates an enlarged view of the flexible cord 130 attached through the attachment hole 120 at the top end 111 of the rod member 110. In one embodiment, the flexible cord 130 is pulled through the attachment hole 120 and knotted at the end 131 which protrudes from the attachment hole 120. The knot in the end 131 of the flexible cord 130 prevents the flexible cord 130 from detaching while a user entertains and exercises his or her domestic animal. The knot in the end 131 of the flexible cord 130 should be larger in diameter than the diameter of the attachment hole 120 to secure the flexible cord 130 in place. Then, while a user is moving around the rod member 110 or while a domestic animal is tugging on the exercising toy (See 140in FIGS. 1 and 3), the flexible cord 130 will pull taught but will not lose contact from the rod member 110 and the user.

The invention is not intended to be limited to the attachment mechanism shown in FIG. 2. Rather, any attachment mechanism which safely and securely attaches the end 131 of the flexible cord 130 to the top end 111 of the rod member 110 will be adequate. The attachment mechanism shown is a preferred embodiment of the invention because it safely and securely attaches the end 131 of the flexible cord 130 to the top end 111 of the rod member 110 while avoiding tangling of the flexible cord 130 and while avoiding the use of complicated, dangerous attachment pieces that may injure the domestic animal.

FIG. 3 illustrates an enlarged view of the flexible cord 130 attached through the connective holes (141-142) in the exercising toy 140. In one embodiment, the flexible cord 130 is pulled in one connective hole 141 in the exercising toy 140 and out the other connective hole 141 in the exercising toy. The end 132 of the flexible cord 130 is then looped around to meet the segment of the flexible cord 130 which enters the exercising toy 140. The end 132 of the flexible cord 130 is then knotted where the segment of the flexible cord 130 which enters the exercising toy 140 meets the end 132 of the flexible cord 130. To prevent injury to the domestic animal and to discourage tangling of the flexible cord 130, the loop formed around and through the exercising toy 140 should be small enough so that the domestic animal's head will not be able to squeeze into the loop, but may be large enough to allow the exercising toy 140 to slide along the flexible cord 130.

The invention is not intended to be limited to the attachment mechanism shown in FIG. 3. Rather, any attachment mechanism which safely and securely attaches the end 132 of the flexible cord 130 to the exercising toy 140 will be adequate. The attachment mechanism shown is a preferred embodiment of the invention because it safely and securely attaches the end 132 of the flexible cord 130 to the exercising toy 140 while avoiding tangling of the flexible cord 130 and while avoiding the use of complicated, dangerous attachment pieces that may injure the domestic animal.

The animal exerciser 100 is manually operated by a user. The user grasps the handle 115 of the rod member 110 and holds the rod member 110 outright so that the flexible cord 130 is unraveled and the exercising toy 140 is left dangling in front of the domestic animal. The user then moves around the rod member 110 by jerking, pulling, and flinging around the rod member 110 which will cause the exercising toy 140 to move around. The movement of the exercising toy 140 will entice a domestic animal to chase it around, and when the domestic animal catches the exercising toy 140, the domestic animal will tug and pull at the exercising toy 140. Such tugging and pulling is resisted by the user's grasp of the rod member 110. The effect of the domestic animal chasing, lunging, and pulling at the exercising toy 140 will be a great workout for the domestic animal, while the user enjoys playing with and entertaining his or her domestic animal.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1-7. (Canceled)

8. An animal exerciser for domestic animals, comprising:
an elongated cylindrical rod having opposing top and bottom ends, said rod having a handle at said bottom end;
a flexible cord having first and second opposing attachment ends, said first opposing attachment end attached to the top end of said rod;
an exercising toy having an attachment hole, said attachment hole having an entrance opening, an exit opening, and a bore connecting said entrance opening and said exit opening;
wherein the second opposing attachment end of said cord passes through said bore and has at least a distal extremity extending outside said exit opening and a proximal portion extending outside said entrance opening of said exercising toy; and
the proximal portion and distal extremity of said second opposing attachment end are joined, securing said exercise toy to the second opposing attachment end of said cord.

9. The animal exerciser of claim 8, wherein said proximal portion and distal extremity of said second opposing attachment end are tied together.

10. The animal exerciser of claim 8 wherein the rod member is a solid wooden rod.
